(19) United States
(12) Patent Application Publication
(10) Pub. No.: US 2008/0175447 A1
(43) Pub. Date: Jul. 24, 2008

(54) Face view determining apparatus and method, and face detection apparatus and method employing the same

(75) Inventors: Jung-bae Kim, Hwaseong-si (KR); Haibing Ren, Beijing (CN); Gyu-tae Park, Anyang-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/892,786

(22) Filed: Aug. 27, 2007

(30) Foreign Application Priority Data
Jan. 24, 2007 (KR) 10-2007-0007663

(51) Int. Cl. G06K 9/00

(52) U.S. Cl. 382/118

(57) ABSTRACT

Provided are an apparatus and method for determining views of faces contained in an image, and face detection apparatus and method employing the same. The face detection apparatus includes a non-face determiner determining whether a current image corresponds to a face, a view estimator estimating at least one view class for the current image if it is determined that the current image corresponds to a face, and an independent view verifier determining a final view class of the face by independently verifying the estimated at least one view class.

### CROSS-REFERENCE TO RELATED PATENT APPLICATION

This application claims the benefit of Korean Patent Application No. 10-2007-0007663, filed on Jan. 24, 2007, in the Korean Intellectual Property Office, the disclosure of which is incorporated herein in its entirety by reference.

### BACKGROUND OF THE INVENTION

1. Field of the Invention

The present invention relates to face detection, and more particularly, to an apparatus and method for determining views of faces contained in an image, and face detection apparatus and method employing the same.

2. Description of the Related Art

Face detection technology is fundamental to many fields, such as digital content management, face recognition, three-dimensional face modeling, animation, avatars, smart surveillance, and digital entertainment, and is becoming more important. Face detection technology is also expanding its application field to a digital camera for use in automatic focus detection. Thus, the default job in the above fields is to detect human faces in a still or a moving image.

The probability that a frontal face exists in an image of interest is very low, and most faces have various views in an Out-of-Plane Rotation (ROP) range of [−45°, +45°] or an In-Plane Rotation (RIP) range of [−30°, +30°]. In order to detect the various views of faces, many general multi-view face detection techniques and pseudo multi-view face detection techniques have been developed.

However, general multi-view face detection techniques and pseudo multi-view face detection techniques involve a large amount of complex computation, resulting in a low algorithm execution speed or the need for an expensive processor, and thus are of limited use in reality.

### SUMMARY OF THE INVENTION

The present invention provides an apparatus and method for quickly and accurately determining views of faces existing in an image.

The present invention also provides an apparatus and method for quickly and accurately detecting faces and views of the faces existing in an image.

The present invention also provides an apparatus and method for quickly and accurately detecting objects and views of the objects existing in an image.

According to an aspect of the present invention, there is provided a face view determining apparatus comprising: a view estimator estimating at least one view class for a current image corresponding to a face; and an independent view verifier determining a final view class of the face by independently verifying the estimated at least one view class.

According to another aspect of the present invention, there is provided a face view determining method comprising: estimating at least one view class for a current image corresponding to a face; and determining a final view class of the face by independently verifying the estimated at least one view class.

According to another aspect of the present invention, there is provided a face detection apparatus comprising: a non-face determiner determining whether a current image corresponds to a face; a view estimator estimating at least one view class for the current image if it is determined that the current image corresponds to a face; and an independent view verifier determining a final view class of the face by independently verifying the estimated at least one view class.

According to another aspect of the present invention, there is provided a face detection method comprising: determining whether a current image corresponds to a face; estimating at least one view class for the current image if it is determined that the current image corresponds to a face; and determining a final view class of the face by independently verifying the estimated at least one view class.

According to another aspect of the present invention, there is provided an object view determining method comprising: estimating at least one view class for a current image corresponding to an object; and determining a final view class of the object by independently verifying the estimated at least one view class.

According to another aspect of the present invention, there is provided an object detection method comprising: determining whether a current image corresponds to a pre-set object; estimating at least one view class for the current image if it is determined that the current image corresponds to the object; and determining a final view class of the object by independently verifying the estimated at least one view class.

According to another aspect of the present invention, there is provided a computer readable recording medium storing a computer readable program for executing any of the face view determining method, the face detection method, the object view determining method, and the object detection method.

### BRIEF DESCRIPTION OF THE DRAWINGS

The patent or application file contains at least one drawing executed in color. Copies of this patent or patent application publication with color drawing(s) will be provided by the Office upon request and payment of the necessary fee. The above and other features and advantages of the present invention will become more apparent by describing in detail exemplary embodiments thereof with reference to the attached drawings in which:

FIG. 1 is a block diagram of a face detection apparatus according to an embodiment of the present invention;

FIG. 2 is a block diagram of a face view determiner illustrated in FIG. 1, according to an embodiment of the present invention;

FIGS. 3A through 3C illustrate Haar features applied to the present invention, and FIGS. 3D and 3E show examples in which the Haar features are applied to a facial image;

FIG. 4 is a block diagram of a non-face determiner illustrated in FIG. 1, according to an embodiment of the present invention;

FIG. 5 is a graph showing a Haar feature distribution corresponding to an arbitrary classifier;

FIG. 6 is a graph showing that the Haar feature distribution illustrated in FIG. 5 is divided into bins of a uniform size;

FIGS. 7A and 7B are flowcharts of a face detection process performed by the non-face determiner illustrated in FIG. 4, according to an embodiment of the present invention;

FIG. 8 illustrates view classes used in an embodiment of the present invention;

FIG. 9 is a diagram for describing the operation of the view estimator illustrated in FIG. 2;

FIG. 10 is a diagram for describing how the view estimator illustrated in FIG. 9 estimates a view class;

FIG. 11 is a block diagram of an independent view verifier illustrated in FIG. 2, according to an embodiment of the present invention; and

FIGS. 12 through 14 illustrate locations and view classes of facial images detected from a single frame image according to an embodiment of the present invention.

### DETAILED DESCRIPTION OF THE INVENTION

The present invention will now be described in detail by explaining preferred embodiments of the invention with reference to the attached drawings.

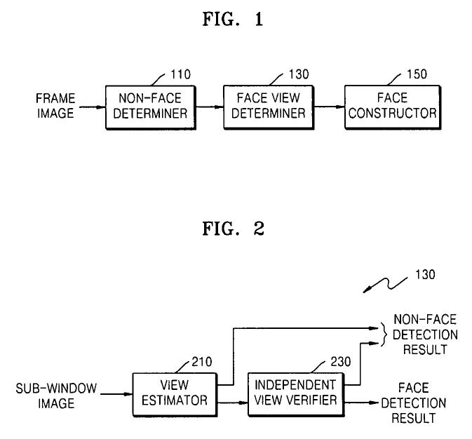

FIG. 1 is a block diagram of a face detection apparatus according to an embodiment of the present invention. Referring to FIG. 1, the face detection apparatus includes a non-face determiner 110, a face view determiner 130, and a face constructor 150.

The non-face determiner 110 determines whether a current sub-window image is a non-face sub-window image regardless of view, i.e. for all views. If it is determined that the current sub-window image is a non-face sub-window image, the non-face determiner 110 outputs a non-face detection result and receives a subsequent sub-window image. If it is determined that the current sub-window image is not a non-face sub-window image, the non-face determiner 110 provides the current sub-window image to the face view determiner.

When it is determined that the current sub-window image corresponds to a face in a single frame image, the face view determiner 130 estimates at least one view class for the current sub-window image and determines a final view class of the face by independently verifying the estimated view class.

The face constructor 150 constructs a face by combining sub-window images for which a final view class is determined by the face view determiner 130. The constructed face can be displayed in a relevant frame image, or coordinate information of the constructed face can be stored or transmitted.

FIG. 2 is a block diagram of the face view determiner 130 illustrated in FIG. 1, according to an embodiment of the present invention. Referring to FIG. 2, the face view determiner 130 includes a view estimator 210 and an independent view verifier 230.

The view estimator 210 estimates at least one view class for a current image corresponding to a face.

The independent view verifier 230 determines a final view class of the current image by independently verifying the view class estimated by the view estimator 210.

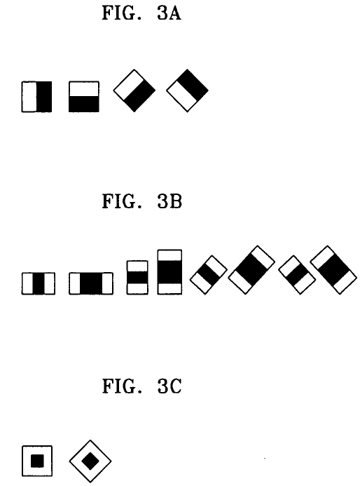

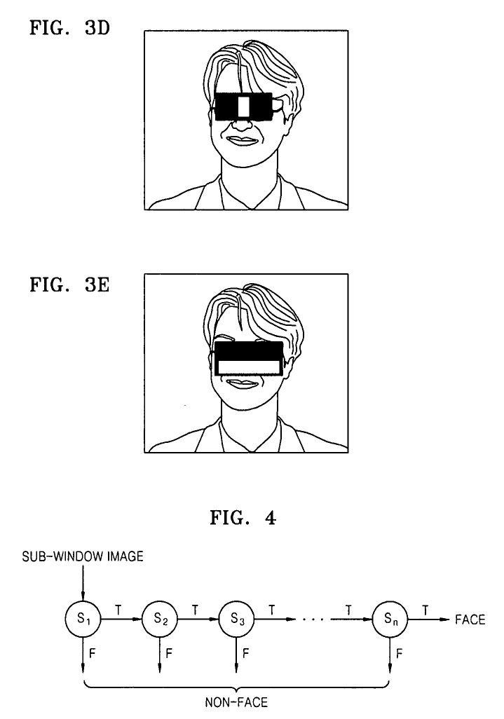

The operation of the non-face determiner 110 illustrated in FIG. 1 will now be described in more detail with reference to FIGS. 3 through 5.

The non-face determiner 110 has a cascaded structure of boosted classifiers operating with Haar features guaranteeing high speed and accuracy with simpler computation. Each classifier has learned simple face features by pre-receiving a plurality of facial images of various views. The face features used by the non-face determiner 110 are not limited to the Haar features, and wavelet features or other features can be used for the face features.

FIGS. 3A through 3C illustrate simple features used by each classifier, wherein FIG. 3A shows an edge simple feature, FIG. 3B shows a line simple feature, and FIG. 3C shows a center-surround simple feature. Each simple feature is formed of 2 or 3 white or black rectangles. According to the simple feature, each classifier subtracts the sum of gradation values of pixels located in a white rectangle from the sum of gradation values of pixels in a black rectangle, and compares the result with a threshold of each bin corresponding to the simple feature. FIG. 3D shows an example of detecting the eye part in a face by using a line simple feature formed of one white rectangle and two black rectangles. Considering that the eye area is darker than the ridge area of a nose, the difference of gradation values between the eye area and the nose ridge area is measured. FIG. 3E shows an example of detecting the eye part in a face by using an edge simple feature formed of one white rectangle and one black rectangle. Considering that the eye area is darker than the cheek area, the difference of gradation values between the eye area and the cheek area is measured. These simple features to detect a face can have a variety of forms.

In detail, the non-face determiner 110 includes n stages S₁ through Sₙ connected in a cascaded structure as illustrated in FIG. 4. Here, each stage (any one of S₁ through Sₙ) performs face detection using classifiers based on simple features, and in this structure, the number of classifiers used in a stage increases as the distance from the first stage increases. For example, the first stage S₁ uses 4 to 5 classifiers, and the second stage 52 uses 15 to 20 classifiers. The first stage S₁ receives a k^{th} sub-window image of a single frame image as an input and performs face detection. If the face detection fails (F), it is determined that the k^{th} sub-window image is a non-face, and if the face detection is successful (T), the k^{th} sub-window image is provided to the second stage S₂. In the last stage of the non-face determiner 110, if face detection in the k-th sub-window image is successful (T), the k^{th} sub-window image is determined to be a face. The selection of each classifier is determined using for example, Adaboost-based learning algorithm. According to the Adaboost algorithm, very efficient classifiers are generated by selecting some important visual characteristics from a large feature set.

According to the stage structure connected in a cascade, a non-face can be determined even with a small number of simple features, and rejected early, such as in the first or second stage for the k^{th} sub-window image. Then, face detection can be performed by receiving a (k+1)^{th} sub-window image. Accordingly, the overall processing speed for face detection can be improved.

Each stage determines whether face detection is successful, from the sum of the output values of a plurality of classifiers. That is, the output value of each stage can be obtained from the sum of the output values of N classifiers, as represented by Equation 1.

$$H = {\sum }_{i = 1}^{N} {h}_{i} ( x ) \qquad ( 1 )$$

Here, hᵢ(x) denotes the output value of an i^{th} classifier of a current sub-window image x. The output value of each stage is compared to a threshold to determine whether the current sub-window image x is a face or non-face. If it is determined that the current sub-window image x is a face, the current sub-window image x is provided to a subsequent stage.

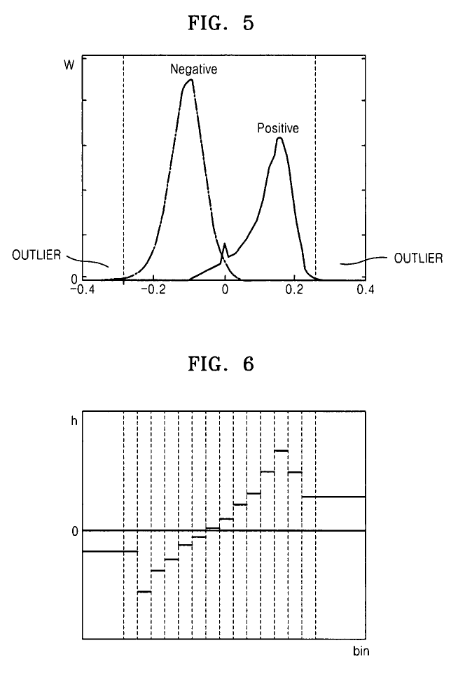

FIG. 5 is a graph showing a weighted Haar feature distribution weighted in an arbitrary classifier included in an arbitrary stage. The classifier divides a feature scope having the Haar feature distribution into a plurality of bins of a uniform size as illustrated in FIG. 6. A simple feature in each bin, e.g.

$$[ \begin{matrix}{T}_{i}^{j - 1} , & {T}_{i}^{j}\end{matrix} ] ,$$

has a reliability value hᵢ^{j} as represented by Equation 2. According to the Haar feature distribution, since each classifier has a different distribution, each classifier needs to store a bin start value, a bin end value, the number of bins, and each bin reliability value hᵢ^{j}. For example, the number of bins can be 256, 64, or 16. A negative class shown in FIG. 5 means a Haar feature distribution due to a non-face training sample set, and a positive class shown in FIG. 5 means a Haar feature distribution due to a face training sample set.

$${h}_{i} ( x ) = \{ \begin{matrix}{h}_{i}^{j} & {T}_{i}^{j - 1} < f ( x ) < {T}_{i}^{j} \\ 0 & otherwise\end{matrix} \qquad ( 2 )$$

Here, ƒ(x) denotes a Haar feature calculation function, and

$${T}_{i}^{j - 1} and {T}_{i}^{j}$$

respectively denote the thresholds of a (j-1)^{th} bin and a j^{th} bin of the i^{th} classifier. That is, an output hᵢ(x) of the i^{th} classifier with respect to the current sub-window image x has a reliability value when the Haar feature calculation function ƒ(x) is within the range, and in this case, the reliability value of the j^{th} bin of the i^{th} classifier can be estimated as represented by Equation 3.

$${h}_{i}^{j} = \frac{1}{2} ln ( \frac{{( {F}_{G} \times W )}_{+}^{i , j} + {W}_{C}}{{( {F}_{G} \times W )}_{-}^{i , j} + {W}_{C}} ) \qquad ( 3 )$$

Here, W denotes a weighted feature distribution, F_{G} denotes a Gaussian filter, ‘+’ and ‘−’ respectively denote a positive class and a negative class, and W_{C} denotes a constant value used to remove outliers as illustrated in FIG. 5.

Although the probability that a sub-window image is located in an outlier is very low, the probability deviation is very large, and thus the outliers are preferably removed when bin locations are calculated. In particular, when the number of training samples is not sufficient, by removing outliers, each bin location can be assigned more accurately. The constant value W_{C} can be obtained according to the number of bins to be assigned, as represented by Equation 4.

$${W}_{C} = \frac{0.01}{N\_bin} \qquad ( 4 )$$

Here, N_bin denotes the number of bins.

By outputting various values according to where an output value of a single classifier is located in a Haar feature distribution, instead of outputting a binary value of ‘−1’ or ‘1’ by comparing an output value of a single classifier to a threshold, more accurate face detection can be achieved.

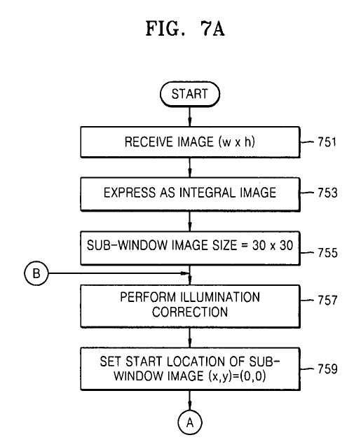

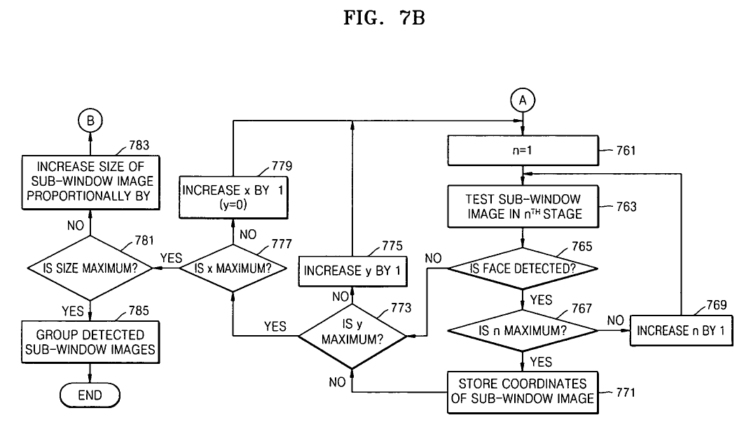

FIGS. 7A and 7B are flowcharts of a face detection process performed by the non-face determiner 110 illustrated in FIG. 4, according to an embodiment of the present invention.

Referring to FIGS. 7A and 7B, a frame image of a size w×h is input in operation 751. In operation 753, the frame image is expressed as an integral image in a form which allows easy extraction of the simple features shown in FIGS. 3A through 3C. The integral image expression method is explained in detail in an article by Paul Viola, “Rapid Object Detection using a Boosted Cascade of Simple Features”, Accepted Conference on Computer Vision and Pattern Recognition, 2001.

In operation 755, the minimum size of a sub-window image is set, and here, an example of 30×30 pixels will be explained. In operation 757, illumination correction for the sub-window image is performed as an option. The illumination correction is performed by subtracting a mean illumination value of one sub-window image from the gradation value of each pixel and dividing the subtraction result by the standard deviation. In operation 759, the location (x, y) of the sub-window image is set to (0, 0), which is the start location.

In operation 761, the number (n) of a stage is set to 1, and in operation 763, by testing the sub-window image in an n^{th} stage, face detection is performed. In operation 765, it is determined whether the face detection is successful in the n^{th} stage. If it is determined in operation 765 that the face detection fails, operation 773 is performed in order to change the location or size of the sub-window image. If it is determined in operation 765 that the face detection is successful, it is determined in operation 767 whether the n^{th} stage is the last stage. If it is determined in operation 767 that the n^{th} stage is not the last one, n is increased by 1 in operation 769, and then operation 763 is performed again. Meanwhile, if it is determined in operation 767 that the n^{th} stage is the last one, the coordinates of the sub-window image are stored in operation 771.

In operation 773, it is determined whether y corresponds to h of the frame image, that is, whether y has reached its maximum. If it is determined in operation 773 that the increase of y is finished, it is determined in operation 777 whether x corresponds to w of the frame image, that is, whether x has reached its maximum. Meanwhile, if it is determined in operation 773 that y has not reached its maximum, y is increased by 1 in operation 775 and then operation 761 is performed again. If it is determined in operation 777 that has reached its maximum, operation 781 is performed, and if it is determined in operation 777 that x has not reached its maximum, x is increased by 1 with no change in y in operation 779, and then operation 761 is performed again.

In operation 781, it is determined whether the size of the sub-window image has reached its maximum. If it is determined in operation 781 that the size of the sub-window image has not reached its maximum, the size of the sub-window image is increased proportionally by a predetermined scale factor in operation 783, and then operation 757 is performed again. Meanwhile, if it is determined in operation 781 that the size of the sub-window image has reached its maximum, the coordinates of the respective sub-window images in which a face stored in operation 771 is detected are grouped in operation 785 and provided to the face view determiner 130.

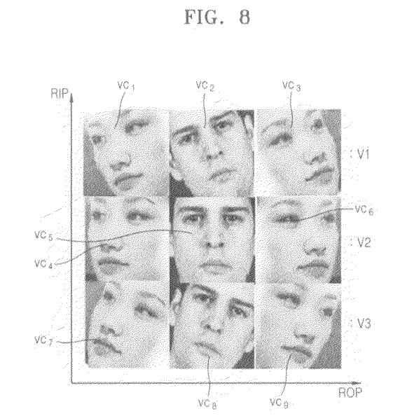

FIG. 8 illustrates view classes used in an embodiment of the present invention. In FIG. 8, 9 view classes obtained by combining a view range of [−45°, +45°] in an Out-of-Plane Rotation (ROP) axis and a view range of [−30°, +30°] in an In-Plane Rotation (RIP) axis are used. When the ROP axis is divided equally into three, the view ranges are [−45°, −15°], [−15°, +15°], and [+15°, +45°], and when the RIP axis is divided equally into three, the view ranges are [−30°, −10°], [−10°, +10°], and [+10°, +30°]. The view classes are determined by combining the view ranges of the ROP axis and the view ranges of the RIP axis. The number of view classes and the view range of a single view class are not limited to the above description, and can be variously changed according to trade-offs between face detection performance and face detection speed, the performance of a processor, or a user's request.

In order for the view estimator 210 to more accurately and quickly perform view estimation, the 9 view classes are classified into first through third view sets V1, V2, and V3, wherein the first view set V1 includes first through third view classes vc₁ through vc₃, the second view set V2 includes fourth through sixth view classes vc₄ through vc₆, and the third view set V3 includes seventh through ninth view classes vc₇ through vc₉. Learning of the 9 view classes has been performed using various images.

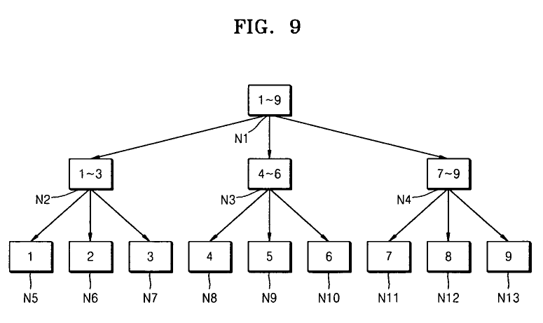

The operation of the view estimator 210 will now be described in more detail with reference to FIG. 9.

Referring to FIG. 9, the view estimator 210 has 3 levels connected in a cascaded structure, including a total of 13 nodes N1 through N13. Each level of the view estimator 210 can be implemented with a boosting structure in which each stage is connected in a cascade as illustrated in FIG. 4. One node N1 exists in the first level, three nodes N2 through N4 exist in the second level, and nine nodes N5 through N13 exist in the third level. N1 of the first level contains a total of 9 view classes, and in the second level, N2 contains the first view set V1 containing the first through third view classes, N3 contains the second view set V2 containing the fourth through sixth view classes, and N4 contains the third view set V3 containing the seventh through ninth view classes. The nodes N5 through N13 of the third level correspond to individual view classes. The nodes in the first and second levels are non-leaf nodes and correspond to the entire view set or partial view sets, and the nodes in the third level correspond to individual view classes. Each non-leaf node has 3 child nodes, and each child node divides a relevant view set into 3 view classes.

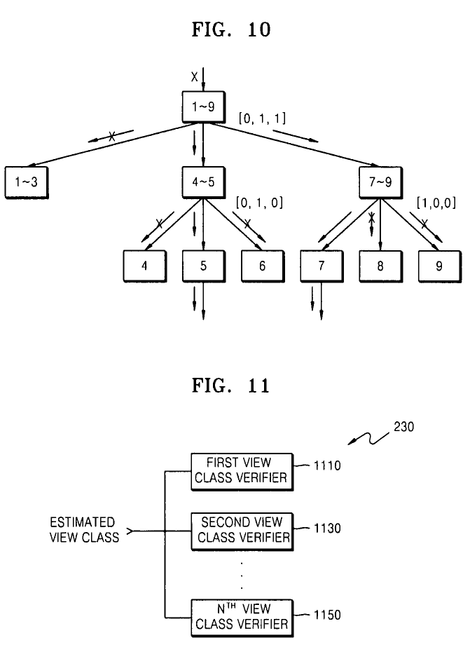

In detail, in the non-leaf node N1 of the first level, partial view sets are estimated by performing view estimation of a current sub-window image with respect to the entire view set containing all view classes. If the partial view sets are estimated in the first level, then individual view classes are estimated in the second level with respect to at least one of the estimated partial view sets, i.e. the first through third view sets, and at least one individual view class existing in the third level is assigned according to the estimation result. Each non-leaf node has a view estimation function Vᵢ(x) and outputs a three-dimensional vector value [a₁, a₂, a₃], where i denotes a node number, and x denotes a current sub-window image. A value of aᵢ (i is 1, 2, or 3) indicates whether the current sub-window image belongs to a view set or an individual view class. If an output value [a₁, a₂, a₃] of an arbitrary non-leaf node is [0, 0, 0], the current sub-window image is not provided to the next level. In particular, if the output value [a₁, a₂, a₃] of the node N1 is [0, 0, 0], or if the output value [a₁, a₂, a₃] of any one of the nodes N2 through N4 is [0, 0, 0], it is determined that the current sub-window image is a non-face. An example of estimating a view class in the view estimator 210 will now be described with reference to FIG. 10

Referring to FIG. 10, if the output value of the non-leaf node N1 of the first level is [0, 1, 1], a current sub-window image is transmitted to the non-leaf nodes N3 and N4 of the second level. If the output value of the non-leaf node N3 is [0, 1, 0], the fifth view class is estimated. If the output value of the non-leaf node N3 is [1, 0, 0], the seventh view class is estimated. As described above, at least one view class can be estimated with respect to a current sub-window image, resulting in a significant decrease of accumulated errors.

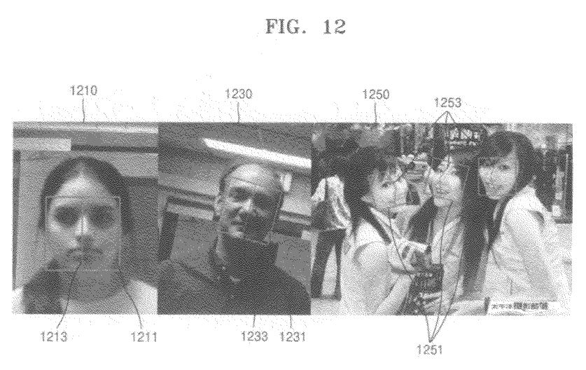

FIG. 11 is a block diagram of the independent view verifier 230 illustrated in FIG. 2, according to an embodiment of the present invention. Referring to FIG. 11, the independent view verifier 230 includes first through N^{th} view class verifiers 1110, 1130, and 1150. When 9 view classes exist according to an embodiment of the present invention, the independent view verifier 230 includes 9 view class verifiers. The first through N^{th} view class verifiers 1110, 1130, and 1150 can be implemented with the boosting structure in which stages are connected in a cascade as illustrated in FIG. 4.

Meanwhile, a total False Alarm Rate (FAR) of view detection and verification can be calculated using Equation 5.

$$\{ \begin{matrix}FAR = \sum {w}_{i} {f}_{i} \\ \sum {w}_{i} = 1\end{matrix} \qquad ( 5 )$$

Here, wᵢ denotes a weight assigned to each view class i, wherein a high weight is assigned to a view class having a statistically high distribution and a low weight is assigned to a view class having a statistically low distribution. For example, a high weight is assigned to the fifth view class vc₅ corresponding to a frontal face. The sum of the weights is 1, since a single view class is assigned to a single face. In addition, ƒᵢ denotes the FAR of each view class i. Thus, since all view class verifiers are used to obtain a view class of a face, when the total FAR is calculated, the total FAR is considerably less than that of a conventional method of calculating the total FAR by adding FARs of all view classes.

According to a face detection algorithm used in embodiments of the present invention, the same detection time is required for estimation and verification of each view class of a face.

The thresholds used in the embodiments of the present invention can be pre-set with optimal values using a statistical or experimental method.

The face view determining method and apparatus and the face detection apparatus and method according to the embodiments of the present invention can be applied to pose estimation and detection of a general object, such as a mobile phone, a vehicle, or an instrument, besides a face.

Simulation results for the performance evaluation of the face detection method according to an embodiment of the present invention will now be described with reference to FIGS. 12 through 14.

FIG. 12 shows face detection results performed in different capturing environments. Referring to FIG. 12, even in the cases of a blurry image 1210, an image 1230 captured under low illumination, and an image 1250 with a complex background, face locations 1211, 1231, and 1251 and view classes 1213, 1233, and 1253 are correctly detected regardless of the pose or rotation. As data used in the simulation, a training database contains 3000 samples, i.e. sub-window images, per view, and a testing database contains 1000 samples per view. In addition, a model trained with 3000 samples per view is used.

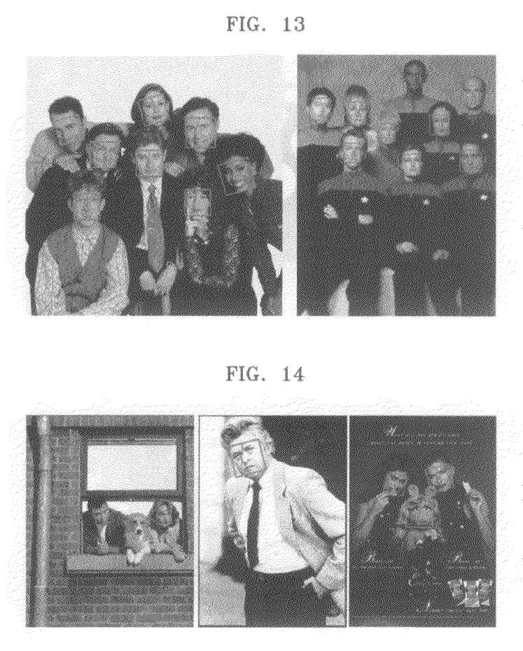

FIG. 13 shows face detection results of images existing in a Carnegie Mellon University (CMU) database. Referring to FIG. 13, even if a plurality of faces having different poses exist in a single image, the locations and view classes of all faces are accurately detected.

FIG. 14 shows face detection results of images existing in the CMU database. Referring to FIG. 14, even if a face in an image has RIP or ROP, the location and view class of each face are accurately detected.

According to the above-described simulation results, the processing speed of the face detection algorithm is high, since 8.5 frame images of 320×240 can be processed per second, and accuracy of the view estimation and verification is very high, i.e. 96.8% for the training database and 85.2% for the testing database.

The invention can also be embodied as computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, code, and code segments for accomplishing the present invention can be easily construed by programmers skilled in the art to which the present invention pertains.

As described above, according to the present invention, by determining whether a sub-window image corresponds to a face, and performing view estimation and verification with respect to only a sub-window image corresponding to a face, faces included in an image can be accurately and quickly detected with relevant view classes.

The present invention can be applied to all application fields requiring face recognition, such as credit cards, cash cards, electronic ID cards, cards requiring identification, terminal access control, public surveillance systems, electronic albums, criminal face recognition, and in particular, to automatic focusing of a digital camera.

While the present invention has been particularly shown and described with reference to exemplary embodiments thereof, it will be understood by those of ordinary skill in the art that various changes in form and detail may be made therein without departing from the spirit and scope of the present invention as defined by the following claims.

1. A face view determining apparatus comprising:
a view estimator estimating at least one view class for a current image corresponding to a face; and
an independent view verifier determining a final view class of the face by independently verifying the estimated at least one view class.

2. The face view determining apparatus of claim 1, wherein the view estimator is implemented by connecting a plurality of levels in the form of a cascade, wherein a higher level is constituted of the entire view set or partial view sets, and a lower level is constituted of individual view classes.

3. The face view determining apparatus of claim 2, wherein the view estimator estimates at least one partial view set in the entire view set, and estimates at least one individual view class in the estimated at least one partial view set.

4. The face view determining apparatus of claim 1, wherein the independent view verifier comprises a plurality of view class verifiers, each implemented by connecting a plurality of stages in the form of a cascade, each stage comprising a plurality of classifiers.

5. A face view determining method comprising:
estimating at least one view class for a current image corresponding to a face; and
determining a final view class of the face by independently verifying the estimated at least one view class.

6. The face view determining method of claim 5, wherein the estimating of the at least one view class comprises:
estimating at least one partial view set in the entire view set containing all view classes; and
estimating at least one individual view class in the estimated at least one partial view set.

7. A computer readable recording medium storing a computer readable program for executing the face view determining method of claim 5 or 6.

8. A face detection apparatus comprising:
a non-face determiner determining whether a current image corresponds to a face;
a view estimator estimating at least one view class for the current image if it is determined that the current image corresponds to a face; and
an independent view verifier determining a final view class of the face by independently verifying the estimated at least one view class.

9. The face detection apparatus of claim 8, wherein the non-face determiner uses Haar features.

10. The face detection apparatus of claim 9, wherein the non-face determiner is implemented by connecting a plurality of stages in the form of a cascade, each stage comprising a plurality of classifiers.

11. The face detection apparatus of claim 8, wherein the view estimator is implemented by connecting a plurality of levels in the form of a cascade,
wherein a higher level is constituted of the entire view set or partial view sets, and a lower level is constituted of individual view classes.

12. The face detection apparatus of claim 11, wherein the view estimator estimates at least one partial view set in the entire view set and estimates at least one individual view class in the estimated at least one partial view set.

13. The face detection apparatus of claim 8, wherein the independent view verifier comprises a plurality of view class verifiers, each implemented by connecting a plurality of stages in the form of a cascade, each stage comprising a plurality of classifiers.

14. A face detection method comprising:
determining whether a current image corresponds to a face;
estimating at least one view class for the current image if it is determined that the current image corresponds to a face; and
determining a final view class of the face by independently verifying the estimated at least one view class.

15. The face detection method of claim 14, wherein the determining of whether the current image corresponds to a face uses Haar features.

16. The face detection method of claim 14, wherein the determining of whether the current image corresponds to a face comprises, if a plurality of stages, each comprising a plurality of classifiers, are connected in the form of a cascade, dividing a feature scope having a weighted Haar feature distribution corresponding to each classifier into a plurality of bins, and determining a bin reliability value to which a value of a Haar feature calculation function belongs as an output of a relevant classifier.

17. The face detection method of claim 16, wherein the determining of whether the current image corresponds to a face comprises removing a portion corresponding to outliers from the weighted Haar feature distribution and dividing the feature scope into a plurality of bins.

18. The face detection method of claim 16, wherein an output value of each stage is represented by the equations below
$$H = {\sum }_{i = 1}^{N} {h}_{i} ( x ) ,$$
where hᵢ(x) denotes an output value of an i^{th} classifier with respect to a current sub-window image x, and
$${h}_{i} ( x ) = \{ \begin{matrix}{h}_{i}^{j} & {T}_{i}^{j - 1} < f ( x ) < {T}_{i}^{j} \\ 0 & otherwise\end{matrix}$$
where ƒ(x) denotes a Haar feature calculation function, and
$${T}_{i}^{j - 1} and {T}_{i}^{j}$$
respectively denote thresholds of a (j-1)^{th} bin and a j^{th} bin of the i^{th} classifier.

19. The face detection method of claim 18, wherein a reliability value of the j^{th} bin of the i^{th} classifier is obtained by the equation below
$${h}_{i}^{j} = \frac{1}{2} ln ( \frac{{( {F}_{G} \times W )}_{+}^{i , j} + {W}_{C}}{{( {F}_{G} \times W )}_{-}^{i , j} + {W}_{C}} ) ,$$
wherein W denotes a weighted feature distribution, F_{G} denotes a Gaussian filter, ‘+’ and ‘−’ respectively denote a positive class and a negative class, and W_{C} denotes a constant value used to remove outliers from the Haar feature distribution.

20. The face detection method of claim 14, wherein the estimating of the at least one view class comprises:
estimating at least one partial view set in the entire view set containing all view classes; and
estimating at least one individual view class in the estimated at least one partial view set.

21. A computer readable recording medium storing a computer readable program for executing the face detection method of any of claims 14 through 20.

22. An object view determining method comprising:
estimating at least one view class for a current image corresponding to an object; and
determining a final view class of the object by independently verifying the estimated at least one view class.

23. An object detection method comprising:
determining whether a current image corresponds to a pre-set object;
estimating at least one view class for the current image if it is determined that the current image corresponds to the object; and
determining a final view class of the object by independently verifying the estimated at least one view class.
